(19) United States
(12) Patent Application Publication
(10) Pub. No.: US 2001/0027068 A1
(43) Pub. Date: Oct. 4, 2001

(54) Contact socket

(76) Inventor: Hans Jost Heimueller, Dudenhofen (DE)

Correspondence Address: Tyco Technology Resources, Suite 450, 4550 New Linden Hill Road, Wilmington, DE, 19808, US

(21) Appl. No.: 09/773,199

(22) Filed: Jan. 31, 2001

(30) Foreign Application Priority Data
Jan. 31, 2000 (EP) 00101873.8

(51) Int. Cl. H01R 11/22

(52) U.S. Cl. 439/851

(57) ABSTRACT

The contact socket is of single-part construction and has a base spring and two spring legs, which are integrally formed on the base spring and both spring legs include contacting sections, facing each other where, as a result of the single-piece construction, the manufacturing process of this contact socket can be optimized and one of the spring legs is supported by an additional support member thereby increasing the resilient force.

### BACKGROUND OF THE INVENTION

The present invention relates to a contact socket for receiving a tab or pin terminal.

### DESCRIPTION OF THE PRIOR ART

A contact socket according to the preamble of claim 1 is disclosed in DE 196 19 514 A1. The known contact sockets have a complicated construction and are therefore difficult to manufacture. These known contact sockets are expensive to manufacture. It is therefore an object of the present invention to provide a contact socket allowing the design of a simpler manufacturing process and which thereby entails lower costs.

### SUMMARY OF THE INVENTION

This object is achieved by a contact socket having two internal spring legs formed on a base spring, contacting sections of the spring legs face each other, and one of the two spring legs is bent in a U-shaped configuration, while the other spring leg is bent linearly, extending slightly obliquely towards the interior of the base spring, characterized in that the linear spring leg is supported by a support member bent in a U-shape configuration.

Accordingly, the contact socket, which is of a single-part construction, has a base spring (or a base part) and two internal spring legs, the contacting sections of which face each other. The single-part construction allows the optimization of the manufacturing process which consists essentially of a bending operation and/or stamping operation.

A further advantage of the contact socket according to the invention is that the resilient force on one of the two spring legs can be relatively easily increased by a support member which is also formed integrally on the base spring, and on the free end thereof one of the spring legs is supported. The resilient force can hereby be considerably increased.

### BRIEF DESCRIPTION OF THE DRAWINGS

FIG. 1 shows a schematic cross-sectional view of a contact socket according to the invention, in accordance with a preferred embodiment of the present invention;

FIG. 2 shows a further cross-sectional view of the contact socket according to FIG. 1;

FIG. 3 shows a layout of the contact socket according to FIGS. 1 and 2; and

FIG. 4 show a diagram for explaining part of the bending operation of a contact socket according to the invention.

### DETAILED DESCRIPTION OF THE PREFERRED EMBODIMENT

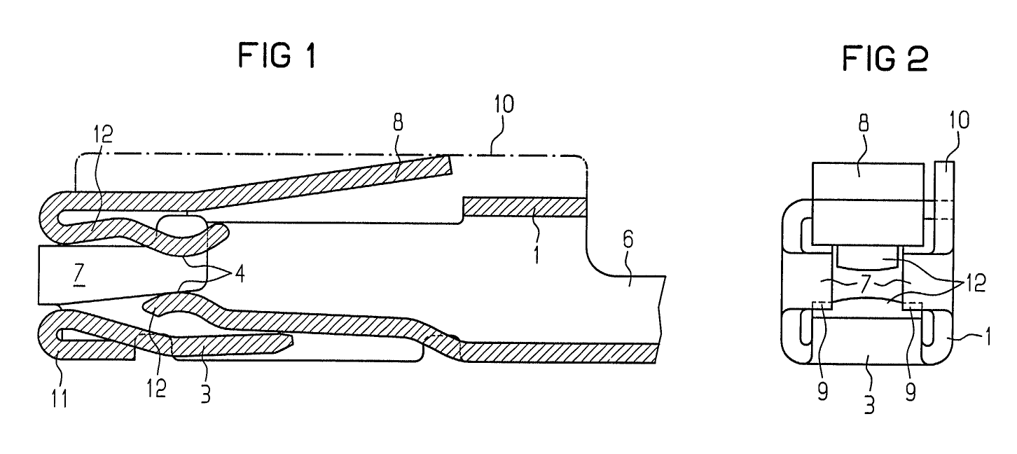

FIGS. 1 and 2 show a contact socket according to the invention in accordance with a preferred embodiment, where a lateral cross-sectional view of a base spring 1 is shown, on which two spring legs 12 are seen, which face each other with their contact sections 4 on the inside of the base spring 1. According to this first embodiment an external latching tongue 8 is formed on the base spring 1 (shown on top in FIGS. 1 and 2). The spring legs 12 lie inside base spring 1. According to the view of FIG. 1, a facing second (lower) spring leg 12 is foreseen on the base spring 1 opposite the first (upper) spring leg 12 such that the contact sections 4 of spring legs 12 face each other in the plug-in direction.

It can furthermore be clearly seen from FIG. 1 and 2 that spring legs 12 are completely accommodated inside the base spring 1. The latching tongue 8 protrudes upwards at an acute angle of approximately 5° beyond the base spring 1. The two spring legs 12 form a readily resilient contact metal piece by which current is directly, and therefore more efficiently, conducted.

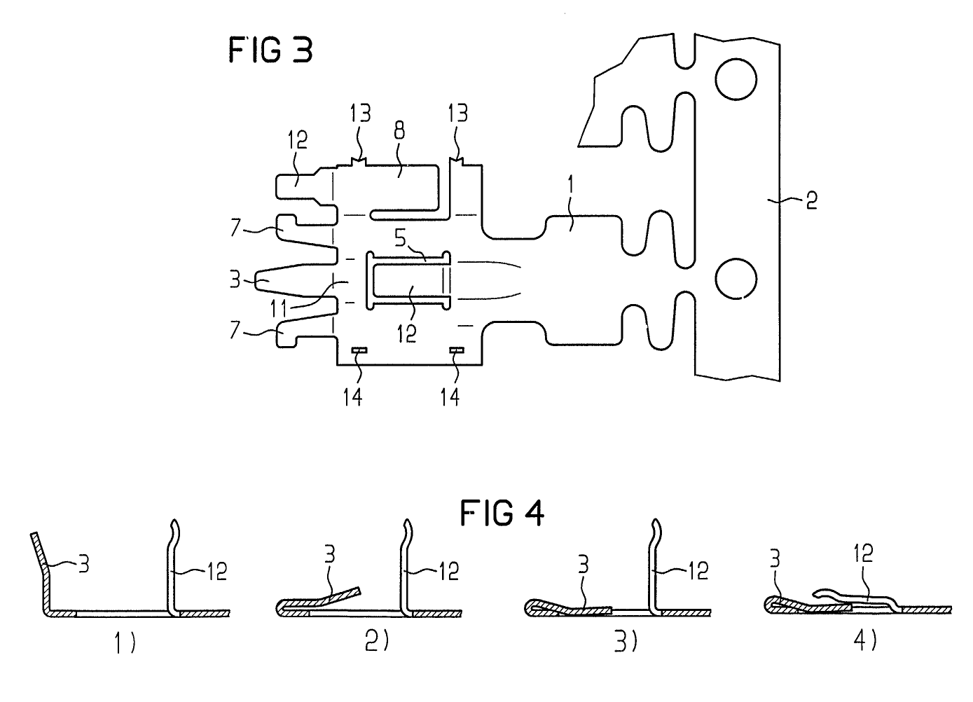

FIG. 3 shows the layout of the base spring 1. This view is not to scale. The layout of the base spring 1 with integral spring legs 12 has a compact form resulting in reduced loss of sheet metal during stamping.

On the base spring 1 a projection 10 is additionally foreseen which is bent approximately at a right angle from base spring 1, as shown in FIG. 2, to form a polarisation of the contact socket. The contours of the layout of base springs 1 are preferably stamped out of flat metal sheets, or possibly cut by laser, as shown in FIG. 3. After the stamping operation, the individual base springs 1 are separated and each bent and/or pressed, until the state shown in FIGS. 1 and 2 is established. The base spring 1 can preferably be soldered by means of a laser, such that a solder pad is set on at least one location on the tool from the top in order to fix base spring 1. The base spring 1 (or base part) can also be fixed by pressing; the projections 13 shown in FIG. 3 come into engagement with apertures 14 and are then pressed such that in this manner the base spring 1 can be stabilised or fixed in its form.

The construction of the present contact socket according to the invention, in particular through the cooperation of both spring legs 12, allows creation of the relatively high resilient force whereby improved spring action of the spring components can be achieved. In the contact socket shown, in order to further increase the spring action, the one spring leg 12 is supported from one free end of a support member 3.

This support member 3 is formed as a further spring member by means of a free punch 5 and is connected to base 11 via a base spring 1. In order to further increase the resilient force of the lower spring leg 12 it is supported by support member 3. The upper spring leg 12 is formed on the top edge of the base spring 1 by backward folding.

Finally, several tabs 7 are formed on both sides of an insertion opening (of base spring 1) for a contact pin (not shown), which tabs show outwardly rounded contours and facilitate the insertion of the contact pin. As can be seen from FIG. 2, the tabs 7 also serve to prevent an insertion behind the lower spring leg 12, since the lower spring leg 12 in its two lateral end sections 9 is prevented by tabs 7 from moving upwards. The lower spring leg 12 cannot be further displaced upwardly than as shown in FIG. 1. In this position of the lower spring leg 12 the lateral end sections 9 lie adjacent to the lower edge of tabs 7. The tabs 7 thereby form a pre-aperture of spring legs 12.

In the embodiment of the contact socket according to the invention shown, the consumption of material is minimized since the loss of sheet metal during stamping is reduced. As is shown in the layout according to FIG. 3, there is little stamping residue.

FIG. 4 shows part of a bending operation of the contact socket according to the invention. The lower spring leg 12 and the support member 3 are bent in five steps. For this purpose, the contact socket is first stamped out. In the first bending step the lower spring leg 12 is then bent upwards, approximately at a right angle from the base plane (extending horizontally in FIG. 4) in an upwardly protruding direction. The support member 3 is then bent upwards and bent backwards as shown in the bending step 2 (with respect to the plug-in direction in the contact socket), into the free punch 5 of the lower spring leg 12. The final position of support member 3 is shown in bending step 3. In the bending step 4 the lower spring leg 12 is further bent forwards until it comes to lie on support member 3. Finally, in a fifth bending step, the position of the lower spring leg 12 is calibrated.

In summary, the contact socket according to the invention, which is of a single-part construction, comprises a base spring 1 and two spring legs 12, which are integrally formed on base spring 1. Both spring legs 12 comprise contacting sections 4, essentially facing each other. As a result of the single-piece construction, the manufacturing process of this contact socket can be optimized. Furthermore, one of the spring legs 12 is supported by an additional support member 3 thereby increasing the resilient force.

For further characteristics and advantages of the present invention, specific reference is hereby made to the appended claims and drawings.

I/we claim:

1. A contact socket, which is of a single-part construction, comprising two internal spring legs formed on a base spring, contacting sections of the spring legs face each other, and one of the two spring legs is bent in a U-shaped configuration, while the other spring leg is bent linearly, extending slightly obliquely towards the interior of the base spring, characterized in that the linear spring leg is supported by a support member bent in a U-shape configuration.

2. The contact socket according to claim 1, characterized in that the base spring comprises a latching tongue which protrudes to the outside of the base spring.

3. The contact socket according to claim 2, characterized in that both free ends of the two spring legs extend in the opposite direction.

4. The contact socket according to claim 3, characterized in that the base spring is made of a copper alloy.

5. The contact socket according to claim 4, characterized in that the support member extends with its free end in the same direction as the free end of the spring leg which is bent in a U-shaped configuration.

6. The contact socket according to claim 5, characterized in that the support member supports spring leg and thereby increases its resilient force.

7. The contact socket according to claim 6, characterized in that the base spring is fixed in the final state by at least one laser soldering point.

8. The contact socket according to claim 7, characterized in that the base spring is manufactured from a flat metal sheet through stamping, bending, and/or pressing.

9. The contact socket according to claim 7, characterized in that the base spring is fixed in its final state by pressing of at least one projection in an aperture.

10. The contact socket according to claim 9, characterized in that a polarisation in the form of a projection is formed on the base spring.

11. The contact socket according to claim 10, characterized in that at least one tab is foreseen on the base spring adjacent to one spring leg, which tab prevents an insertion behind spring leg.

12. The contact socket according to claim 11, characterized in that on both sides of a spring leg a tab is a pre-aperture.
